(19) United States
(12) Patent Application Publication
(10) Pub. No.: US 2016/0372785 A1
(43) Pub. Date: Dec. 22, 2016

(54) METHOD FOR MANUFACTURING LITHIUM ION CONDUCTIVE SULFIDE COMPOUND, LITHIUM ION CONDUCTIVE SULFIDE COMPOUND MANUFACTURED BY THE SAME, AND SOLID ELECTROLYTE AND ALL SOLID BATTERY COMPRISING THE SAME

(71) Applicants: Hyundai Motor Company, Seoul (KR); Korea Institute of Science and Technology, Seoul (KR)

(72) Inventors: Yong Jun Jang, Seongnam (KR); Ju Young Sung, Suwon (KR); Yong Sung Lee, Seongnam (KR); Ho Taek Lee, Seoul (KR); Hyoung Chul Kim, Seoul (KR); Jong Ho Lee, Seoul (KR); Hun Gi Jung, Seoul (KR); Soo Young Cho, Seoul (KR)

(21) Appl. No.: 14/963,773

(22) Filed: Dec. 9, 2015

(30) Foreign Application Priority Data
Jun. 16, 2015 (KR) 10-2015-0085033

(51) Int. Cl. H01M 10/0562; H01M 10/0525

(52) U.S. Cl. CPC H01M 10/0562; H01M 10/0525; H01M 2220/30

(57) ABSTRACT

Disclosed are a method for manufacturing a lithium ion conductive sulfide compound, a lithium ion conductive sulfide compound manufactured by the same, and a solid electrolyte and an all solid battery comprising the same. Particularly, the lithium ion conductive sulfide compound that is manufactured by milling at low temperature so as to increase brittleness of raw materials has differentiated particle distribution, crystal structure and mixing property from the conventional one.

### CROSS-REFERENCE TO RELATED APPLICATION

This application claims under 35 U.S.C. §119(a) the benefit of Korean Patent Application No. 10-2015-0085033 filed on Jun. 16, 2015, the entire contents of which are incorporated herein by reference.

### TECHNICAL FIELD

The present disclosure relates to a method for manufacturing a lithium ion conductive sulfide compound, a lithium ion conductive sulfide compound manufactured by the same, and a solid electrolyte and an all solid battery comprising the same. Particularly, the lithium ion conductive sulfide compound may be manufactured by milling low temperature so as to increase brittleness of raw materials, and thus, have differentiated particle distribution, crystal structure and mixing property from the conventional sulfide compound.

### BACKGROUND

Secondary batteries have been widely used from large devices such as vehicles, power storage systems and the like to small devices such as mobile phones, camcorders, notebooks and the like.

As application area of the secondary battery has been increased, the demand for safety improvement and high performance of the battery are rising.

Among the secondary batteries, a lithium secondary battery has advantages of higher energy density and larger capacity per unit area than a nickel-manganese battery or a nickel-cadmium battery.

However, an electrolyte used in the conventional lithium secondary battery has been mostly a liquid electrolyte such as organic solvent. Thus, safety problems such as electrolyte leakage and the risk of fire have occurred.

Accordingly, an interest in an all solid battery that uses an inorganic solid electrolyte instead of an organic liquid electrolyte has been rising recently in order to increase safety.

The solid electrolyte typically has greater safety than the liquid electrolyte due to its non-flammability or flame retardance.

The solid electrolyte is generally classified into an oxide-based one and a sulfide-based one. For instance, the sulfide-based solid electrolyte has greater lithium ion conductivity and is safe in a wide voltage range as being compared to the oxide-based solid electrolyte. Thus, the sulfide-based solid electrolyte has been mostly used.

However, the currently developed sulfide-based solid electrolyte for an all solid battery has still less lithium ion conductivity than the liquid electrolyte.

In a certain example, Japanese Patent Laid-Open Publication No. H11-134937 and Japanese Patent Laid-Open Publication No. 2002-109955 disclose a sulfide-based solid electrolyte, which is manufactured by grinding raw materials by high energy milling technique using a planetary mill. Both of the inventions have provided a sulfide-based solid electrolyte having improved lithium ion conductivity, however there were limits in the manufacturing methods.

Although a sulfide-based compound has substantial ductility, when a milling technique generating a lot of heat is used for the sulfide-based compound, the raw materials may not be homogeneously mixed, and that atomization may not be sufficiently conducted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the above-described problems associated with prior art.

In preferred aspects, the present invention provides a method for manufacturing a lithium ion conductive sulfide compound that may be used as a solid electrolyte of an all solid battery. For instance, the lithium ion conductive sulfide compound may be manufactured by homogeneously mixing raw materials and atomizing thereof.

The present invention is not limited to the above objects. The objects of the present invention will be more apparent from the following description, and may be implemented by means defined in the appended claims or their combinations.

To achieve the above objects, the present invention includes the following constitutions.

In one aspect, the present invention provides a method for manufacturing a lithium ion conductive sulfide compound, and the method may comprise: preparing a mixture of a sulfide-based raw material and lithium sulfide (Li₂S); first milling, in which the mixture is milled at a first milling temperature (T1); second milling, in which the resulting material of the first milling step is milled at a second milling temperature (T2); and heating the resulting material of the second milling step.

In a preferred embodiment, the first milling temperature (T1) of the first milling may be less than the second milling temperature (T2) of the second milling.

In another preferred embodiment, the T1 may be of about −300° C. to about −1° C.

In still another preferred embodiment, in the first milling step, the T1 temperature condition may be established by using liquid nitrogen (LN₂), liquid hydrogen (LH₂), liquid oxygen (LO₂), liquid carbon dioxide (LCO₂) or dry ice.

In yet another preferred embodiment, the first milling step may be repeatedly conducted two times to four times.

In still yet another preferred embodiment, the T2 may be of about 1° C. to 25° C.

In a further preferred embodiment, the second milling step may be conducted at about 400 to 800 RPM for about 4 hours to 12 hours.

In another further preferred embodiment, the sulfide-based raw material may be phosphorus pentasulfide (P₂S₅).

In still another further preferred embodiment, the heating step may be conducted at a temperature of about 200° C. to 400° C. for about 1 min to 100 hours.

In another aspect, the present invention provides a lithium ion conductive sulfide compound that may be manufactured according to the above method. Further, lithium ion conductive sulfide compound may be used as a solid electrolyte of an all solid battery comprising Li₂S and P₂S₅.

In a preferred embodiment, the lithium ion conductive sulfide compound may have two peaks at 2θ in a range of about 16° to 20° at X-ray diffraction analysis, and intensity of the peak shown at the lower 2θ value of the two peaks may be less than or equal to intensity of the peak shown at the higher 2θ value.

In another preferred embodiment, the lithium ion conductive sulfide compound may have four peaks at 2θ in a range of about 21° to 27° at X-ray diffraction analysis, and intensity difference among the four peaks may be within about 5%.

In still another preferred embodiment, the lithium ion conductive sulfide compound may show two peaks at 2θ in a range of about 28° to 31° at X-ray diffraction analysis, and intensity of the peak shown at the lower 2θ value of the two peaks may be less than or equal to intensity of the peak shown at the higher 2θ value.

In yet another preferred embodiment, intensity of the peak shown between about 415 cm⁻¹ and about 425 cm⁻¹ at Raman spectroscopy analysis may be greater than intensity of the peak shown between about 400 cm⁻¹ and about 410 cm⁻¹.

In still another aspect, the present invention provides a solid electrolyte comprising the lithium ion conductive sulfide compound as described herein.

In a further aspect, the present invention provides an all solid battery comprising the solid electrolyte.

In a preferred aspect, the all solid battery may comprise Li₂S and P₂S₅.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A shows a scanning electron microscope (SEM) image of an exemplary lithium ion conductive sulfide compound (Li₇P₃S₁₁) manufactured in Example according to an exemplary embodiment of the present invention;

FIG. 1B shows a scanning electron microscope (SEM) image of a lithium ion conductive sulfide compound (Li₇P₃S₁₁) manufactured in Comparative Example;

FIG. 2 shows results of XRD analysis of an exemplary lithium ion conductive sulfide compound (Li₇P₃S₁₁) manufactured in Example according to an exemplary embodiment of the present invention and a lithium ion conductive sulfide compound (Li₇P₃S₁₁) in Comparative Example;

FIG. 3 shows results of Raman spectroscopy analysis of an exemplary lithium ion conductive sulfide compound (Li₇P₃S₁₁) manufactured in Example according to an exemplary embodiment of the present invention and a lithium ion conductive sulfide compound (Li₇P₃S₁₁) in Comparative Example; and

FIG. 4 shows results of measuring lithium ion conductivity of an exemplary lithium ion conductive sulfide compound (Li₇P₃S₁₁) manufactured in Example according to an exemplary embodiment of the present invention and a lithium ion conductive sulfide compound (Li₇P₃S₁₁) in Comparative Example.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Herein, “having high ductility” means that a material is extended rather than destroyed when force, which exceeds elastic limit, is applied to the material, and “having high brittleness” means that a material is easily broken or destroyed when force is applied to the material.

In manufacturing a lithium ion conductive sulfide compound which can be used as a sulfide-based solid electrolyte of an all solid battery, the present invention goes through a low temperature milling step before conducting high energy milling step using a planetary mill. By cooling sulfide that is a ductile material at low temperature, brittleness may be improved.

Accordingly, the lithium ion conductive sulfide compound having microstructure may be obtained, which is distinguished from the conventional solid electrolyte. The lithium ion conductive sulfide compound may particularly form aggregates comprising atomized particles, and needle-shaped and plate-shaped samples. Consequently, lithium ion conductivity of the lithium ion conductive sulfide compound may be substantially improved.

Hereinafter, the present invention will be described in detail.

The method for manufacturing the lithium ion conductive sulfide compound of the present invention may comprise: a step of preparing a mixture of a sulfide-based raw material and lithium sulfide (Li₂S); a first milling step, in which the mixture is milled at a first milling temperature (T1); a second milling step, in which the resulting material of the first milling step is milled at a second milling temperature (T2); and a step of heating the resulting material of the second milling step.

The sulfide-based raw material may be phosphorus sulfide such as P₂S₃, P₂S₅, P₄S₃, P₄S₅, P₄S₇ and P₄S₁₀, preferably phosphorus pentasulfide (P₂S₅).

Further, the sulfide-based raw material may further comprise a substitution atom, and the substitution atom may be at least one selected from the group consisting of boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), selenium (Se), silver (Ag), cadmium (Cd), indium (In), tin (Sn), antimony (Sb), tellurium (Te), lead (Pb), and bismuth (Bi).

Preferably, the lithium sulfide may be the one containing a few impurities in order to inhibit side reaction. The lithium sulfide may be synthesized by the method of Japanese Patent Laid-Open Publication No. 7-330312 (JP 7-330312 A), and it may be purified by the method of PCT patent publication No. WO 2005/040039.

The first milling step may be milling the mixture of the sulfide-based raw material and the lithium sulfide at low temperature (T1). Because the mixture is a sulfide-based compound, it may have high ductility in itself. In addition, because heat is generated during the milling process, ductility of the mixture may become higher. Accordingly, when simply milling the mixture, the mixture may be sagged rather than destroyed and atomized.

In particular, the mixture may be ground at low temperature, or substantially reduced temperature. Because the mixture is ground in the state of high brittleness, it may be homogeneously mixed and atomized. Accordingly, the final material of the present invention, i.e., the lithium ion conductive sulfide compound may form unique ion distribution and crystal structure, which are different from the conventional solid electrolyte.

The first milling step may be conducted at a first milling temperature (T1). The T1 may range from about −300° C. to about −1° C., preferably. In order to sufficiently increase brittleness of the mixture as well as secure economical efficiency of the manufacturing method, the temperature should be within the said temperature range. When the T1 is less than about −300° C., there may be many limitations such as equipment, place and the like, and When the T1 is greater than about −1° C., brittleness of the mixture may sufficiently increase.

In order to secure the T1 temperature, a commercial refrigerant such as liquid nitrogen (LN₂), liquid hydrogen (LH₂), liquid oxygen (LO₂), liquid carbon dioxide (LCO₂), or dry ice may be used. In certain example, the mixture may be rapidly cooled by continuously spraying super low temperature liquid gas of about −60° C. or lower into an agitator.

The first milling step may be conducted at T1 temperature for about 1 min to 100 hours.

The first milling step may be conducted once, or repeatedly conducted at least two times. In order to sufficiently improve brittleness of the mixture and also secure economical efficiency, the first milling may be conducted two times to four times for about 17 min per each time.

The first milling may be conducted by using any one of a vibration mixer mill or a spex mill at the temperature of T1.

For example, the vibration mixer mill or the spex mill is a device for milling a vial containing the mixture together with a refrigerant in a bath. Accordingly, it is easy to establish a rapid cooling condition, and also the temperature can be constantly maintained at low temperature. Further, because the mixture is contained in a vial, contamination of the mixture by the refrigerant may be prevented.

The vibration mixer mill may grind the mixture by left-right linear motion of a grinding ball in a vial or grinding container with high frequency. Because frictional force and impact force are generated between the grinding ball and the grinding container, the mixture may be effectively ground.

The frequency of the grinding ball may be from about 10 Hz to about 100 Hz. The frequency should be within the said range to mix and grind the mixture sufficiently. If the frequency is greater than about 100 Hz, there may be no effect according to frequency increase, and therefore, electric power use may increase unnecessarily.

The spex mill may grind the mixture by left-right linear motion and rotary motion of a grinding ball in a vial or a grinding container with high frequency. Because frictional force and impact force are largely generated between the grinding ball and the grinding container, the mixture may be effectively ground.

The second milling step may be milling and vitrificating the resulting material of the first milling step by a high energy milling process.

The second milling step may be conducted at the second milling temperature (T2). The T2 may range from about 1° C. to about 25° C. But, the temperature may rise by heat generated in the milling process. If the temperature is increased greater than the predetermined range, for example, greater than about 25° C., grinding efficiency may not be sufficient. Preferably, the temperature may be controlled to maintain around room temperature because grinding efficiency may be reduced at too high temperature.

The second milling step may be conducted by using a ball mill such as a power ball mill, a vibration ball mill, a planetary ball mill and the like, using a container fixed-type mixing grinding machine such as spiral-type, ribbon-type, screw-type and high speed-type machines, and the like, and a hybrid mixing grinding machine such as cylinder-type, twin cylinder-type, horizontal cylinder-type, V-type and double cone-type machines, and the like. For example, the ball mill may be preferred since additional grinding effect may be generated by shear force. In a certain example, the planetary ball mill may be very favorable to vitrificate because high impact energy is generated by rotation of a port and revolution of a flat tray.

The second milling step may be conducted by using the planetary ball mill at about 400 to 800 RPM for about 4 to 12 hours. Bead used in the planetary ball mill may be alumina bead or strengthened alumina bead, but zirconia bead may be used suitably.

Diameter (φ) of the zirconia bead may be of about 0.05 mm to 20 mm, or particularly of about 1 mm to 10 mm. If the diameter is less than about 0.05 mm, it may be difficult to treat the bead, and contamination may occur by the bead. If the diameter is greater than about 20 mm, it may be difficult to further grind the resulting material already ground in the first milling step.

The heating step may complete the lithium ion conductive sulfide compound by conducting heating at a temperature of about 200° C. to 400° C. for about 1 min to 100 hours.

When the heating temperature is less than about 200° C., and the heating time is less than about 1 min, it may be difficult to form crystal structure of the lithium ion conductive sulfide. When the temperature is greater than about 400° C. and the time is greater than about 100 hours, conductivity of the lithium ion in the lithium ion conductive sulfide compound may be reduced.

The present invention may provide the lithium ion conductive sulfide compound, which is manufactured by the above manufacturing method and used as a solid electrolyte of an all solid battery comprising Li₂S and P₂S₅.

The all solid battery may comprise the positive electrode, the negative electrode and a solid electrolyte layer interposed between the positive electrode and the negative electrode.

The lithium ion conductive sulfide compound may become the solid electrolyte layer.

The lithium ion conductive sulfide compound may be included in an amount of about 50 to 100 volume %, based on 100 volume % of the solid electrolyte layer. Preferably, the lithium ion conductive sulfide compound may be included in an amount of 100 volume % because it may improve output of the all solid battery.

The solid electrolyte layer may be formed by a method for compression molding of the lithium ion conductive sulfide. Thickness of the solid electrolyte layer may be of about 0.1 μm to 1000 μm, or particularly of about 0.1 μm to 300 μm.

The positive electrode may comprise a positive electrode active material. The positive electrode active material may be layered-type oxide, spinel-type oxide, olivine-type oxide or sulfide-based oxide, which is possible to intercalate or deintercalate lithium ion. For example, it may be lithium-cobalt oxide, lithium-manganese complex oxide such as lithium-nickel-cobalt-manganese oxide, lithium-iron-phosphorus oxide, titanium sulfide (TiS₂), molybdenum sulfide (MoS₂), iron sulfide (FeS or FeS₂), copper sulfide (CuS) and nickel sulfide (Ni₃S₂).

The negative electrode may comprise a negative electrode active material. The negative electrode active material may be a silicon-based material, a tin-based material, a lithium metal-based material or a carbon material, preferably a carbon material. The carbon material may be artificial graphite, graphite carbon fiber, resin-calcined carbon, thermal decomposition vapor grown carbon, coke, mesocarbon microbeads (MCMB), furfuryl alcohol resin-calcined carbon, polyacene, pitch-based carbon fiber, vapor grown carbon fiber, natural graphite and non-graphitizable carbon, preferably artificial graphite.

The all solid battery may comprise a current collector in charge of collecting current on both of the electrodes. The positive electrode current collector may be SUS, aluminum, nickel, iron, titanium or carbon, and the negative electrode current collector may be SUS, copper, nickel or carbon and the like.

Thickness or shape of the positive electrode current collector and the negative electrode current collector may be properly selected according to use of the battery and the like.

Shape of the all solid battery may be coin-type, laminate-type, cylinder-type, rectangular type and the like. A method for manufacturing the all solid battery is not particularly limited, and it may be a method of manufacturing an electricity generation element by sequentially pressing lithium ion conductive sulfide, materials constituting the positive electrode and materials constituting the negative electrode, encasing the electricity generation element in a case, and coking thereof.

### Examples

The following examples illustrate the invention and are not intended to limit the same.

### Example

### Manufacturing Li₇P₃S₁₁[(Li₂S)_{0.7}(P₂S₅)_{0.3}] According to the Present Invention

1) Lithium sulfide (Aldrich, Li₂S, purity: 99.9%) and phosphorus pentasulfide (Aldrich, P₂S₅, purity: 99.9%) were mixed at molar ratio of Li₂S:P₂S₅=70:30 to obtain a mixture.

2) The mixture was sealed in a milling container containing grinding medium. The mixture was rapidly cooled by soaking the milling container in a bath containing liquid nitrogen (LN₂, −196° C.) for 10 min. The milling container was installed to a vibration mixer mill, and milled at a condition of 30 Hz for 17 min. The above procedure was repeated three times, and mixed and ground powder was recovered.

3) The powder, which passed through the first milling step, was sealed in a planetary mill container containing zirconia (ZrO₂) beads, and then ground at a condition of 650 rpm for 8 hours at room temperature (20° C.˜25° C., 1 atm).

4) The vitrificated power obtained by the second milling step was heated at 260° C. for 2 hours to obtain crystallized lithium ion conductive sulfide compound (Li₇P₃S₁₁).

### Comparative Example

### Manufacturing of Li₇P₃S₁₁ by Simple Grinding

The procedure of Example was repeated except only passing through the second milling step, not the first milling step, to manufacture lithium ion conductive sulfide compound (Li₇P₃S₁₁).

### Test Example 1

### SEM Measurement

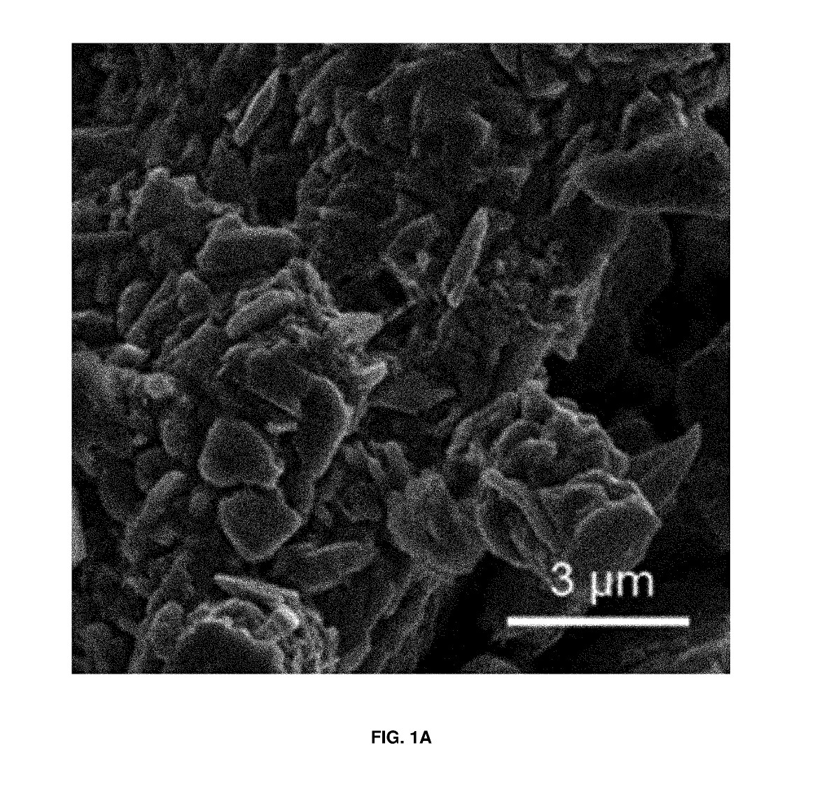

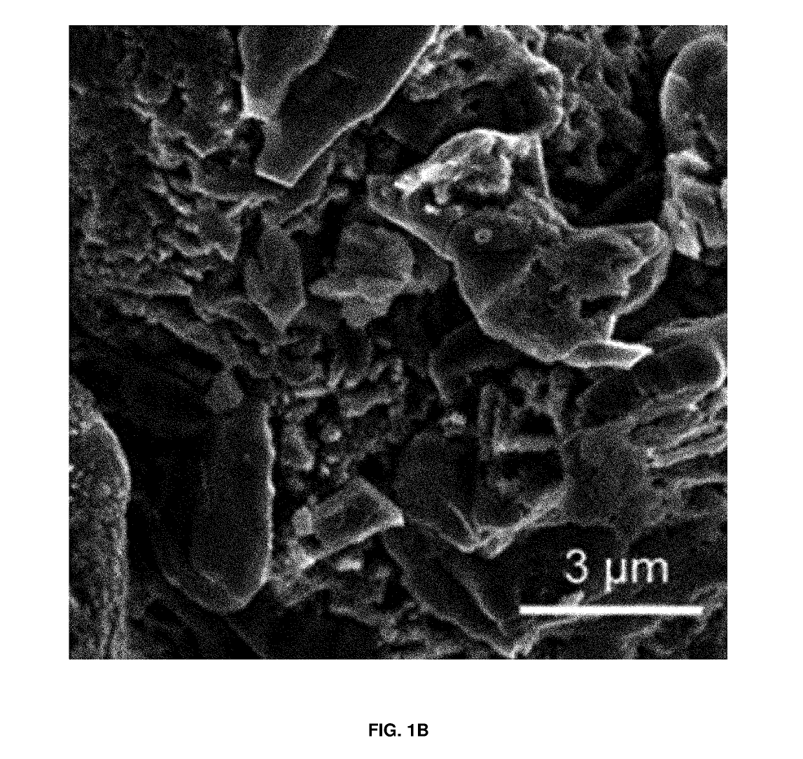

FIGS. 1A-1B are scanning electron microscope (SEM) images of an exemplary lithium ion conductive sulfide compound (Li₇P₃S₁₁) manufactured in Example and a conventional lithium ion conductive sulfide compound (Li₇P₃S₁₁) in Comparative Example.

FIG. 1A is for Example, and FIG. 1B is for Comparative Example.

Referring to this, it can be confirmed that primary particles of the lithium ion conductive sulfide compound manufactured by conducting low temperature grinding in Example may be more atomized in size than those of Comparative Example, and may form a cluster.

Further, it can be confirmed that crystal shape of the lithium ion conductive sulfide compound of Example may be closer to a needle-shape or a plate-shape.

This means that crystal structure of the lithium ion conductive sulfide compound may be certainly changed by passing through the low temperature grinding step (First milling step).

### Test Example 2

### XRD Analysis

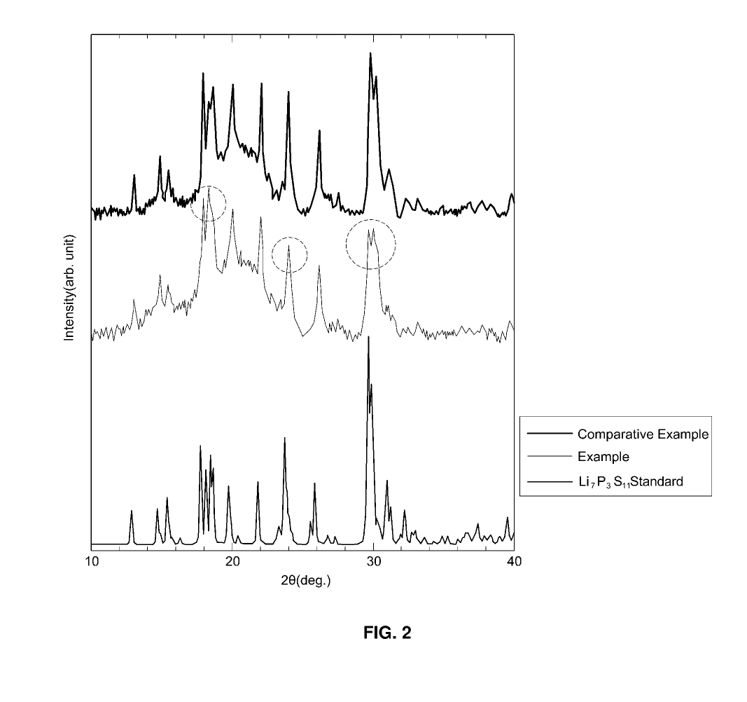

FIG. 2 is the result of XRD analysis of an exemplary lithium ion conductive sulfide compound (Li₇P₃S₁₁) manufactured in Example and a conventional lithium ion conductive sulfide compound (Li₇P₃S₁₁) in Comparative Example.

Referring to this, it can be confirmed that the result of Example is largely different from the result of Comparative Example. In particular, intensity ratios of main peaks (peak ratio) were different in a range of 2 θ=16° to 20°, a range of 2 θ=21° to 27°, and a range of 2 θ=28° to 31°.

In Example, two peaks were shown in a range of 2 θ=16° to 20°, and intensity of the peak shown at the lower 2θ value of the two peaks was less than or equal to intensity of the peak shown at the higher 2θ value.

Further, intensity difference among the four main peaks shown in a range of 2 θ=21° to 27° was within 5%, and intensities of the peaks were similar.

Further, two peaks were shown in a range of 2θ of about 28° to 31°, and intensity of the peak shown at the lower 2θ value of the two peaks was less than or equal to intensity of the peak shown at the higher 2θ value.

Because each compound shows unique XRD pattern, it can be confirmed that crystal structures of the lithium ion conductive sulfide compound of Example and Comparative Example are completely different.

### Test Example 3

### Raman Spectroscopy Analysis

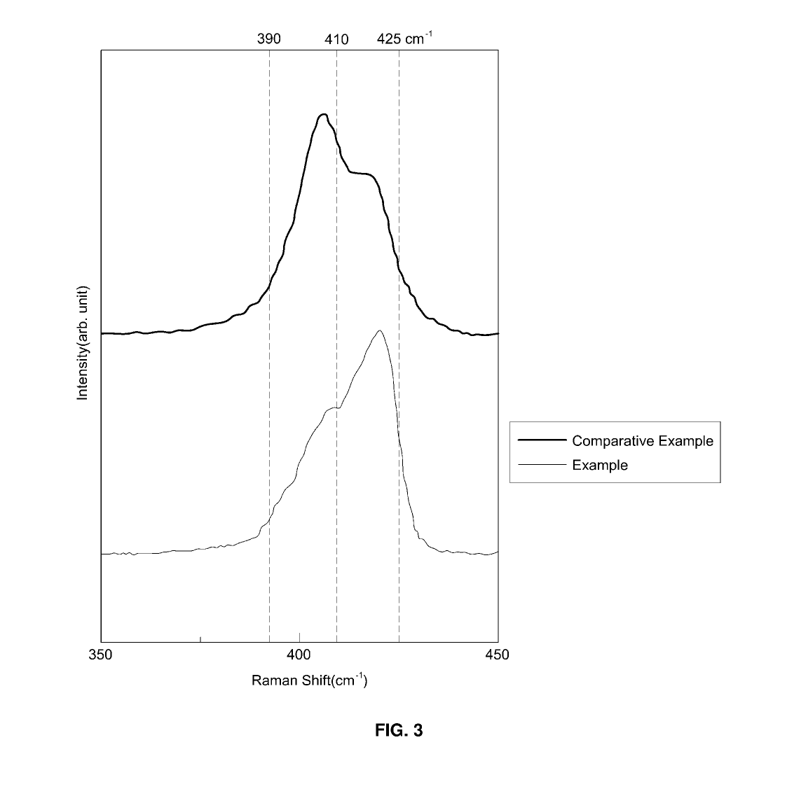

FIG. 3 is the result of Raman spectroscopy analysis of an exemplary lithium ion conductive sulfide compound (Li₇P₃S₁₁) manufactured in Example and a conventional lithium ion conductive sulfide compound (Li₇P₃S₁₁) in Comparative Example.

In general, Raman spectroscopy analysis is used to understand condition of solid, power and the like.

In Comparative Example, a characteristic asymmetry peak was detected around 400 cm⁻¹. It can be confirmed that the peak is a mixed peak of complex ingredients because the peak is asymmetry. In particular, peaks at 425 cm⁻¹, 410 cm⁻¹ and 390 cm⁻¹ can be identified as PS₄³⁻, P₂S₇⁴⁻, and P₂S₆⁴⁻, respectively (M. Tachez, J.-P. Malugani, R. Mercier, and G. Robert, Solid State Ionics, 14, 181 (1984)).

In Comparative Example, the peak having the maximum intensity was shown in a range of 400 cm⁻¹ to 410 cm⁻¹, but in Example, the peak having the maximum intensity was shown in a range of 415 cm⁻¹ to 425 cm⁻¹.

Accordingly, it can be confirmed that the lithium ion conductive sulfide compound of Example has crystal structure, which is distinguished from that of Comparative Example.

### Test Example 4

### Lithium Ion Conductivity Measurement

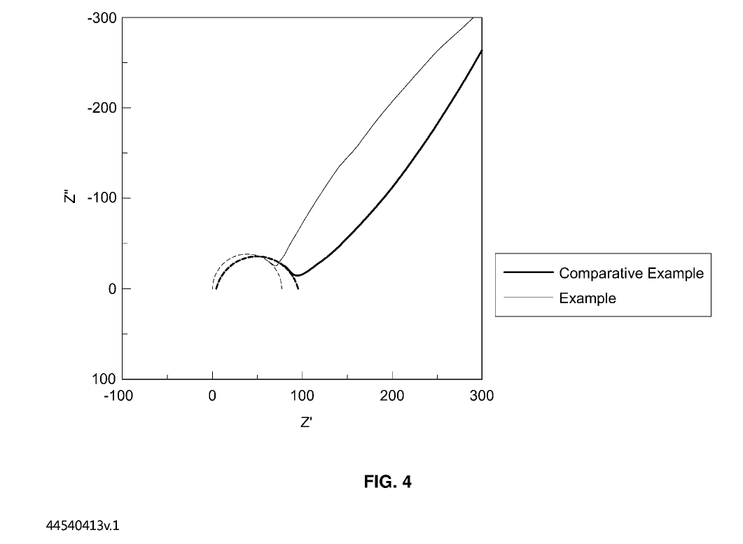

FIG. 4 is the result of measuring lithium ion conductivity of an exemplary lithium ion conductive sulfide compound (Li₇P₃S₁₁) manufactured in Example and a conventional lithium ion conductive sulfide compound (Li₇P₃S₁₁) in Comparative Example.

Measurement of lithium ion conductivity was conducted by a method of making a molded body for measurement (diameter: 6 mm, thickness: 0.6 mm) by pressing the lithium ion conductive sulfide compound with pressure of 100 MPa at 250° C., and then measuring alternating current impedance of the molded body at room temperature.

Lithium ion conductivity of Comparative Example was 2.35×10⁻³ S/cm, but that of Example was 3.34×10⁻³ S/cm.

When manufacturing the lithium ion conductive sulfide compound through the low temperature grinding step, lithium ion conductivity was improved about 42%. The reason is that the lithium ion conductive sulfide compound was further atomized by the low temperature grinding step, thereby having homogeneously distributed crystal structure.

The present invention has the following effect because of comprising the above-mentioned constitutions.

According to the method for manufacturing lithium ion conductive sulfide compound according to the present invention, effect of improving lithium ion conductivity can be obtained because the sulfide-based raw material and the lithium sulfide are homogeneously mixed and atomized well.

Effects of the present invention are not limited to the above-mentioned effect. It is to be understood to effects of the present invention includes all effects deducible from the detailed description.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a lithium ion conductive sulfide compound, comprising:
preparing a mixture of a sulfide-based raw material and lithium sulfide (Li₂S);
first milling the mixture at a first milling temperature (T1);
second milling the resulting material after the first milling at a second milling temperature (T2); and
heating the resulting material from the second milling.

2. The method of claim 1, which the first milling temperature (T1) is less than the second milling temperature (T2).

3. The method of claim 1, wherein the first milling temperature (T1) is from about −300° C. to about −1° C.

4. The method of claim 1, wherein the first milling temperature (T1) is established by using liquid nitrogen (LN₂), liquid hydrogen (LH₂), liquid oxygen (LO₂), liquid carbon dioxide (LCO₂) or dry ice.

5. The method of claim 1, wherein the first milling is repeatedly conducted two times to four times.

6. The method of claim 1, wherein the second milling temperature (T2) is from about 1° C. to about 25° C.

7. The method of claim 1, wherein the second milling is conducted at about 400 to 800 RPM for about 4 hours to 12 hours.

8. The method of claim 1, wherein the sulfide-based raw material is phosphorus pentasulfide (P₂S₅).

9. The method of claim 1, wherein the heating is conducted at a temperature of about 200° C. to 400° C. for about 1 minute to 100 hours.

10. A lithium ion conductive sulfide compound manufactured by a method of claim 1, wherein the lithium ion conductive sulfide compound is used as a solid electrolyte of an all solid battery comprising Li₂S and P₂S₅.

11. The lithium ion conductive sulfide compound of claim 10, which has two peaks at 2θ in a range of about 16° to 20° in X-ray diffraction analysis, and
intensity of the peak shown at the lower 2θ value of the two peaks is less than or equal to intensity of the peak shown at the higher 2θ value.

12. The lithium ion conductive sulfide compound of claim 10, which has four peaks at 2θ in a range of about 21° to 27° in X-ray diffraction analysis, and
intensity difference among the four peaks is within 5%.

13. The lithium ion conductive sulfide compound of claim 10, which has two peaks at 2θ in a range of about 28° to 31° in X-ray diffraction analysis, and
intensity of the peak shown at the lower 2θ value of the two peaks is less than or equal to intensity of the peak shown at the higher 2θ value.

14. The lithium ion conductive sulfide compound of claim 10, wherein intensity of the peak shown between about 415 cm⁻¹ and about 425 cm⁻¹ at Raman spectroscopy analysis is higher than intensity of the peak shown between about 400 cm⁻¹ and about 410 cm⁻¹.

15. A solid electrolyte comprising a lithium ion conductive sulfide compound of claim 10.

16. An all solid battery comprising a solid electrolyte of claim 15.

17. The all solid battery of claim 16, wherein the all solid battery comprises Li₂S and P₂S₅.
